(19) United States
(12) Patent Application Publication
(10) Pub. No.: US 2020/0344088 A1
(43) Pub. Date: Oct. 29, 2020

(54) NETWORK INTEROPERABILITY SUPPORT FOR NON-VIRTUALIZED ENTITIES

(71) Applicant: VMware, Inc., Palo Alto, CA (US)

(72) Inventors: Meenakshi SELVARAJ, Pleasanton, CA (US); Harish KANAKARAJU, Sunnyvale, CA (US)

(73) Assignee: VMware, Inc., Palo Alto, CA (US)

(21) Appl. No.: 16/396,773

(22) Filed: Apr. 29, 2019

(51) Int. Cl. H04L 12/46; H04L 12/24; H04L 12/715; H04L 12/721; H04L 12/935

(52) U.S. Cl. CPC H04L 12/462; H04L 12/4633; H04L 41/0893; H04L 49/3009; H04L 45/64; H04L 45/66; H04L 45/04

(57) ABSTRACT

Example methods and systems for providing network interoperability support for a non-virtualized entity in a network environment. The method may comprise: based on configuration information that is generated by a management entity and associated with a network interoperability support service, performing security verification and one or more configuration operations to configure a network interoperability support service on the network device; and obtaining policy information associated with the network interoperability support service. The method may also comprise: in response to detecting an ingress packet travelling from a virtualized computing environment towards the non-virtualized entity, or an egress packet travelling from the non-virtualized entity, performing the network interoperability support service by processing the ingress packet or egress packet based on the policy information.

### BACKGROUND

Virtualization allows the abstraction and pooling of hardware resources to support virtual machines in a virtualized computing environment, such as a software-defined data center (SDDC). For example, through server virtualization, virtual machines running different operating systems may be supported by the same physical machine (also referred to as a “host”). Each virtual machine is generally provisioned with virtual resources to run an operating system and applications. The virtual resources may include central processing unit (CPU) resources, memory resources, storage resources, network resources, etc. In practice, however, it may not be feasible to virtualize some physical devices (e.g., legacy devices) due to various constraints. In this case, there may be network interoperability issues that affect network performance.

### BRIEF DESCRIPTION OF DRAWINGS

FIG. 1 is a schematic diagram illustrating an example network environment in which network interoperability support for a non-virtualized entity may be provided;

FIG. 2 is a flowchart of an example process for a network device to provide network interoperability support for a non-virtualized entity in a network environment;

FIG. 3 is a flowchart of an example process for configuring a network device to provide network interoperability support for a non-virtualized entity in a network environment;

FIG. 4 is a schematic diagram illustrating an example architecture for a network device configured to provide network interoperability support for a non-virtualized entity;

FIG. 5 is a schematic diagram illustrating an example network interoperability support for non-virtualized entities to implement service chaining;

FIG. 6 is a flowchart of a first example process for a network device to provide network interoperability support for a non-virtualized entity to implement service chaining; and

FIG. 7 is a flowchart of a second example process for a network device to provide network interoperability support for a non-virtualized entity.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein.

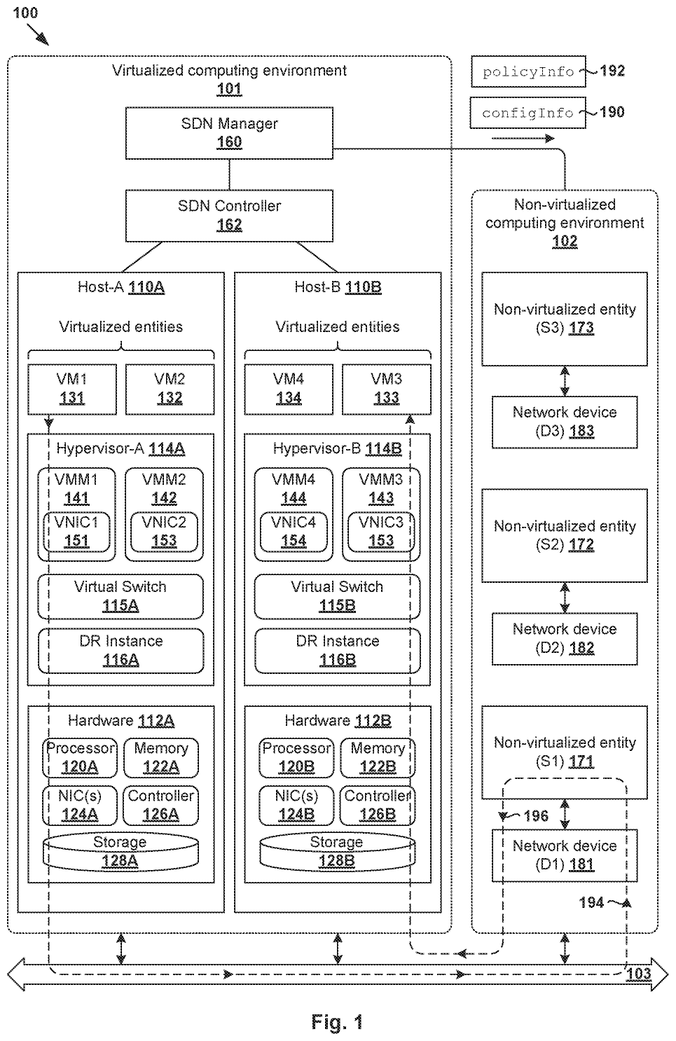

Challenges relating to network interoperability will now be explained in more detail using FIG. 1, which is a schematic diagram illustrating example network environment in which network interoperability support for non-virtualized entities may be provided. It should be understood that, depending on the desired implementation, network environment 100 may include additional and/or alternative components than that shown in FIG. 1. Network environment 100 may include virtualized computing environment 101 in which hosts 110A-B supports virtualization, and non-virtualized computing environment 102 in which various physical entities (e.g., non-virtualized entities 171-173) are not virtualized. These environments 101-102 and associated network interoperability issues will be discussed in more detail below.

(a) Virtualized Computing Environment

In the example in FIG. 1, virtualized computing environment 101 includes multiple hosts 110A-B that are inter-connected via physical network 103. In practice, virtualized computing environment 101 may include any number of hosts (also known as a “host computers”, “host devices”, “physical servers”, “server systems”, “transport nodes,” etc.). Each host may be supporting tens or hundreds of virtual machines (VMs), such as host-A 110A supporting VMs 131-132 and host-B 110B supporting VMs 133-134. Hosts 110A-B may each include virtualization software (e.g., hypervisor-A 114A, hypervisor-B 114B) that maintains a mapping between underlying hardware 112A/112B and virtual resources allocated to VMs 131-134.

Hardware 112A/112B includes suitable physical components, such as processor(s) 120A/120B; memory 122A/122B; physical network interface controller(s) or NIC(s) 124A/124B; and storage disk(s) 128A/228B accessible via storage controller(s) 126A/126B, etc. Virtual resources are allocated to each VM to support a guest operating system (OS) and applications (not shown for simplicity). Corresponding to hardware 112A/112B, the virtual resources may include virtual CPU, virtual memory, virtual disk, virtual network interface controller (VNIC), etc. Hardware resources may be emulated using virtual machine monitors (VMMs) 141-144, which may be considered as part of (or alternatively separated from) corresponding VMs 133-134. For example, VNICs 151-154 are virtual network adapters that are emulated by corresponding VMMs 141-144. Hosts 110A-B may be interconnected via a physical network formed by various intermediate network devices, such as physical network devices (e.g., physical switches, physical routers, etc.) and/or logical network devices (e.g., logical switches, logical routers, etc.).

Although examples of the present disclosure refer to VMs, it should be understood that a “virtual machine” running on a host is merely one example of a “virtualized computing instance.” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 114A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models.

Hypervisor 114A/114B implements virtual switch 115A/115B and logical distributed router (DR) instance 116A/116B to handle egress packets from, and ingress packets to, corresponding VMs. In a software-defined networking (SDN) environment, logical switches and logical DRs may be implemented in a distributed manner and can span multiple hosts. For example, logical switches that provide logical layer-2 connectivity, i.e., an overlay network, may be implemented collectively by virtual switches 115A-B and represented internally using forwarding tables (not shown) at respective virtual switches 115A-B. The forwarding tables may each include entries that collectively implement the respective logical switches. Further, logical DRs that provide logical layer-3 connectivity may be implemented collectively by DR instances 116A-B and represented internally using routing tables (not shown) at respective DR instances 116A-F. The routing tables may each include entries that collectively implement the respective logical DRs.

Through virtualization of networking services in virtualized computing environment 100, logical networks (also referred to as overlay networks or logical overlay networks) may be provisioned, changed, stored, deleted and restored programmatically without having to reconfigure the underlying physical hardware architecture. A logical network may be formed using any suitable tunneling protocol, such as Virtual eXtensible Local Area Network (VXLAN), Stateless Transport Tunneling (STT), Generic Network Virtualization Encapsulation (GENEVE), etc. For example, VXLAN is a layer-2 overlay scheme on a layer-3 network that uses tunnel encapsulation to extend layer-2 segments across multiple hosts which may reside on different layer 2 physical networks. In the example in FIG. 1, VM1 131 on host-A 110A and VM3 133 on host-B 110B may be connected to the same logical switch and located on the same logical layer-2 segment, such as a segment with VXLAN (or “virtual”) network identifier (VNI)=6000.

SDN controller 162 and SDN manager 160 are example network management entities in network environment 100. One example of an SDN controller is the NSX controller component of VMware NSX® (available from VMware, Inc.) that operates on a central control plane. SDN controller 162 may be a member of a controller cluster (not shown for simplicity) that is configurable using SDN manager 160 operating on a management plane. Network management entity 160/162 may be implemented using physical machine(s), VM(s), or both. Logical switches, logical routers, and logical overlay networks may be configured using SDN controller 162, SDN manager 160, etc. Hosts 110A-B may also maintain data-plane connectivity via physical network 103 to facilitate communication among VMs located on the same logical overlay network. Hypervisor 114A/114B may implement a virtual tunnel endpoint (VTEP) (not shown) to encapsulate and decapsulate packets with an outer header (also known as a tunnel header) identifying the relevant logical overlay network (e.g., using a VNI added to a header field). For example in FIG. 1, hypervisor-A 114A implements a first VTEP associated with (IP address=IP-A, MAC address=MAC-A, VTEP label=VTEP-A), hypervisor-B 114B implements a second VTEP with (IP-B, MAC-B, VTEP-B), etc. Encapsulated packets may be sent via a tunnel established between a pair of VTEPs over physical network 103, over which respective hosts are in Layer 3 connectivity of one another.

(b) Non-Virtualized Computing Environment

In practice, it is not always feasible to virtualize some physical devices that reside in non-virtualized computing environment 102. For example in FIG. 1, non-virtualized entities 171-173 (labelled “S1” to “S3,” respectively) may be legacy devices, physical workloads, physical Internet-of-things (IoT) devices, third-party devices or specialized devices that cannot be virtualized. Virtualization may not be feasible due to various constraints, such as hardware limitations, software limitations, cost constraints, performance constraints, technology obsolescence, or any combination thereof, etc.

Unlike hosts 110A-B, non-virtualized entities 171-173 cannot take advantage of virtualization technology to distribute various network functions to hypervisor 114A-B, such as service chaining, firewall implementation, deep packet inspection, virtual private network (VPN) function, etc. Further, non-virtualized entities 171-173 may be built by different vendors, and have different hardware and software stacks. In some scenarios, non-virtualized entities 171-173 may evolve differently from the (more advanced) network functions supported by hypervisors 114A-B. This split in the ecosystem may lead to network interoperability issues that affect the performance of various network operations. This also makes it challenging to manage hosts 110A-B and non-virtualized entities 171-173 in a systematic manner.

As such, network interoperability issues may arise in network environment 100 due to various incompatibilities, such as generational mismatch, vendor mismatch, performance mismatch, management mismatch, etc. In practice, a generational mismatch may occur between two entities, such as when one entity implements VXLAN whereas another entity implements GENEVE. Any incompatibility between these protocols is likely result in functionality loss. Vendor mismatch may occur when competing technological solutions implemented by different vendors are used. In some cases, some vendors rely on proprietary protocols that are difficult to interoperate with without support from the vendors. Performance mismatch may occur when throughput and latency characteristics of two entities are substantially different, which in turn leads to performance bottleneck. Management mismatch may occur when management interfaces may be different for different network functions, especially when solutions by different network vendors are deployed and a unified policy is not available.

Further, network interoperability relating to location dependence may occur when an entity depends on a non-virtualized (and non-distributed) entity for a network function (e.g., VPN). In this case, it may not be feasible to support the network function (e.g., due to technical or economic constraint) unless specialized hardware and software stacks are implemented. When dealing with numerous incompatible network entities, capital and operational costs as well as complexities are generally amplified. The capital costs may include cost of new equipment, software, energy and space. The operation costs may include integration and maintenance costs. The abovementioned network interoperability issues may result in performance degradation in network environment 100.

Network Interoperability Support

According to examples of the present disclosure, network performance may be improved by providing network interoperability support for non-virtualized entities in network environment 100. For example in FIG. 1, network devices 181-183 (also referred to as “gateway devices” or “proxy devices”) may be deployed to provide network interoperability support for respective non-virtualized entities 171-173. As used herein, the term “network interoperability support” or “network interoperability support service” may refer generally to any suitable operation(s) to facilitate interaction of non-virtualized entities 171-173 with virtualized computing environment 101 and various network functions. As will be exemplified below, network interoperability support may be provided to facilitate service chaining, micro-segmentation, network observability service(s), sidecar proxy service(s), tunneling service(s), any combination thereof.

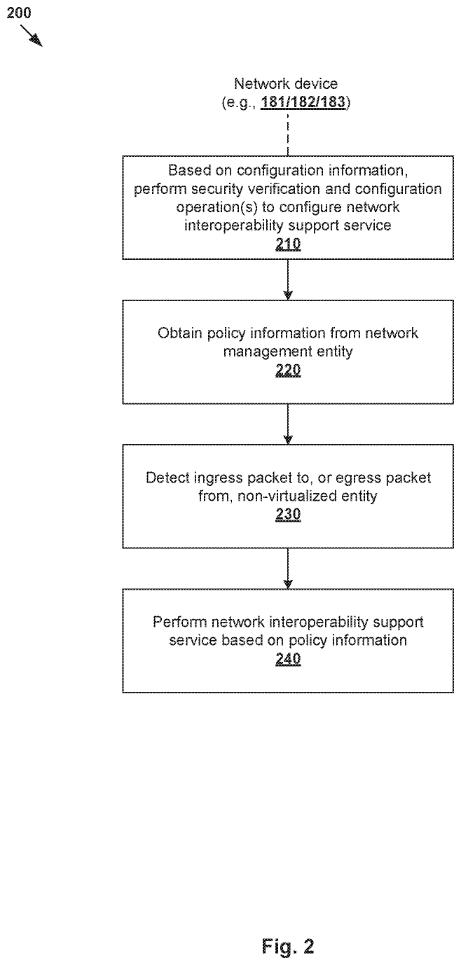

In more detail, FIG. 2 is a flowchart of example process 200 for network device 181/182/183 to provide network interoperability support for non-virtualized entity 171/172/173 in network environment 100. Example process 200 may include one or more operations, functions, or actions illustrated by one or more blocks, such as 210 to 240. The various blocks may be combined into fewer blocks, divided into additional blocks, and/or eliminated depending on the desired implementation. In practice, example process 200 may be implemented using any suitable computer system capable of acting as network device 181/182/183, etc. An example will be explained with reference to FIG. 1 using “network device” 181, “non-virtualized entity” 171, and “management entity” 160 in the form of an SDN manager.

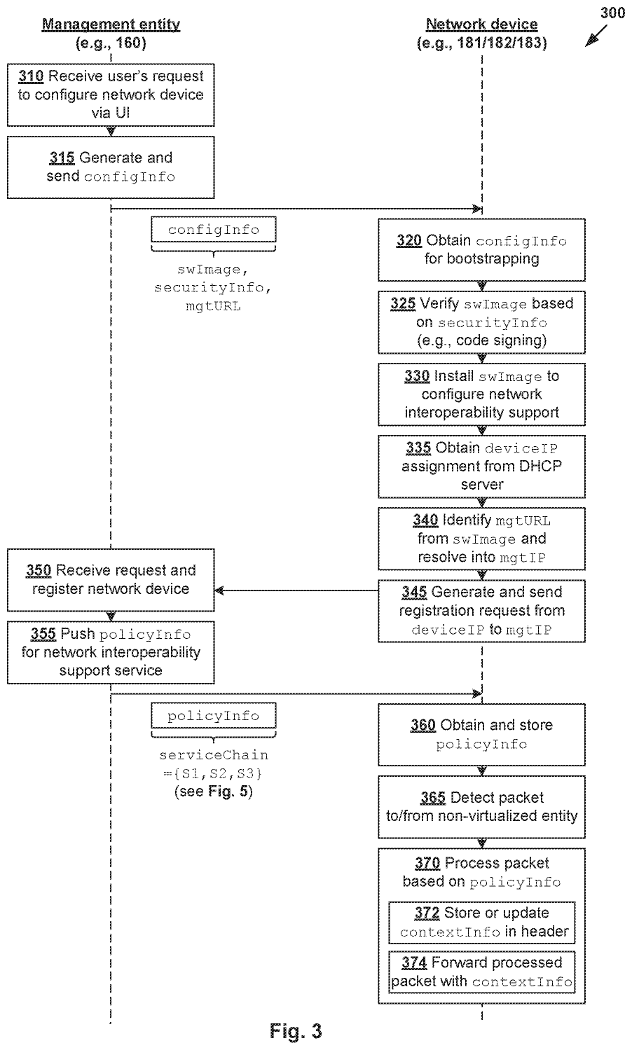

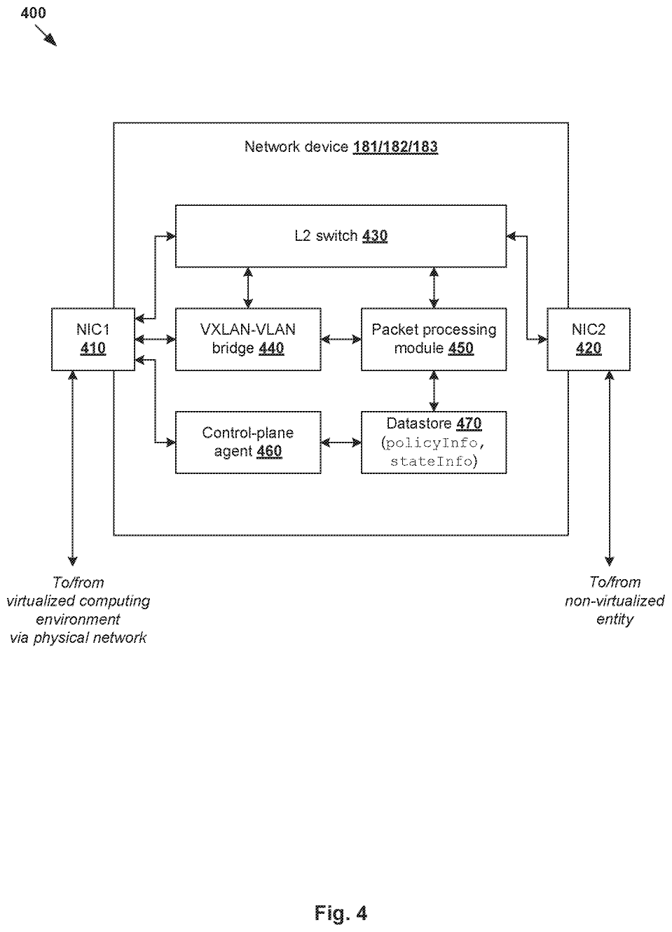

At 210 in FIG. 2, based on configuration information (see 190 in FIG. 1) that is generated by management entity 160 and associated with a network interoperability support service, network device 181 may perform security verification and one or more configuration operations to configure a network interoperability support service on network device 181. As will be discussed using FIG. 3, block 210 may involve performing security verification based on security information in the configuration information prior to installing software image information to configure the network interoperability support service. As will be discussed using FIG. 4, block 210 may include configure a bridging module, layer-2 switching module, control-plane agent and packet processing module of network device 181.

At 220 in FIG. 2, network device 181 may obtain, from management entity 160, policy information (see 192 in FIG. 1) associated with the network interoperability support service. Here, the term “obtain” or “obtaining” may refer generally to network device 181 retrieving, receiving or requesting the required information from management entity 160 or any source (e.g., datastore) associated with management entity 160, etc. The policy information may be any suitable control information that may facilitate the implementation of the network interoperability support service. As will be discussed using FIG. 3, block 220 may involve network device 181 determining address information associated with management entity 160 based on configuration information 190, as well as generating and sending a request to management entity 160 using the address information to register network device 181 and to obtain policy information 192.

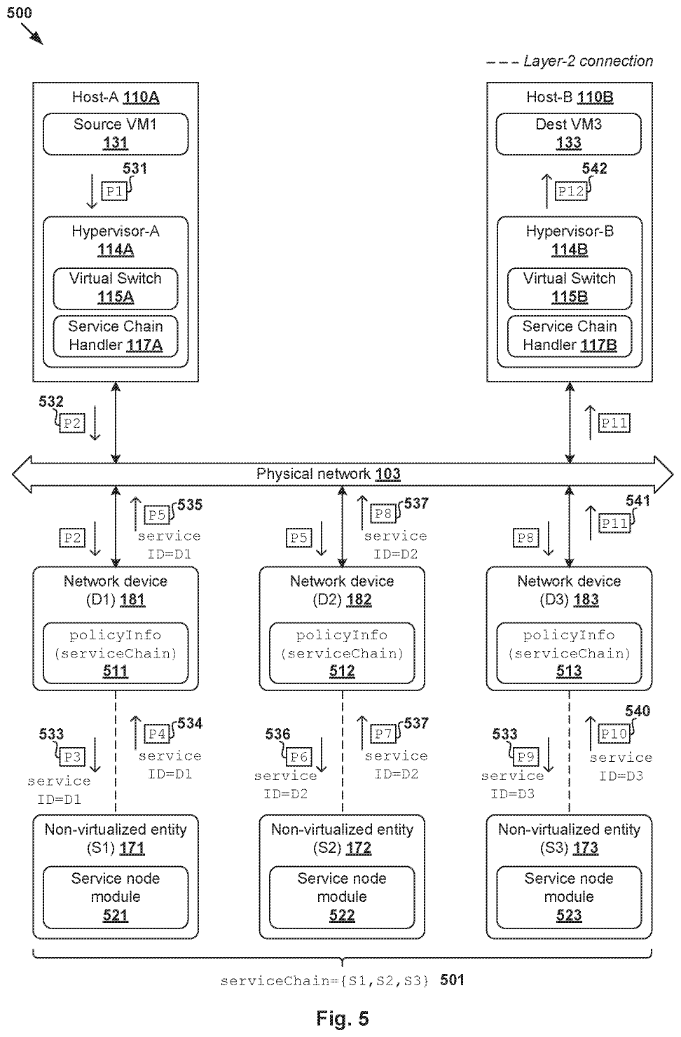

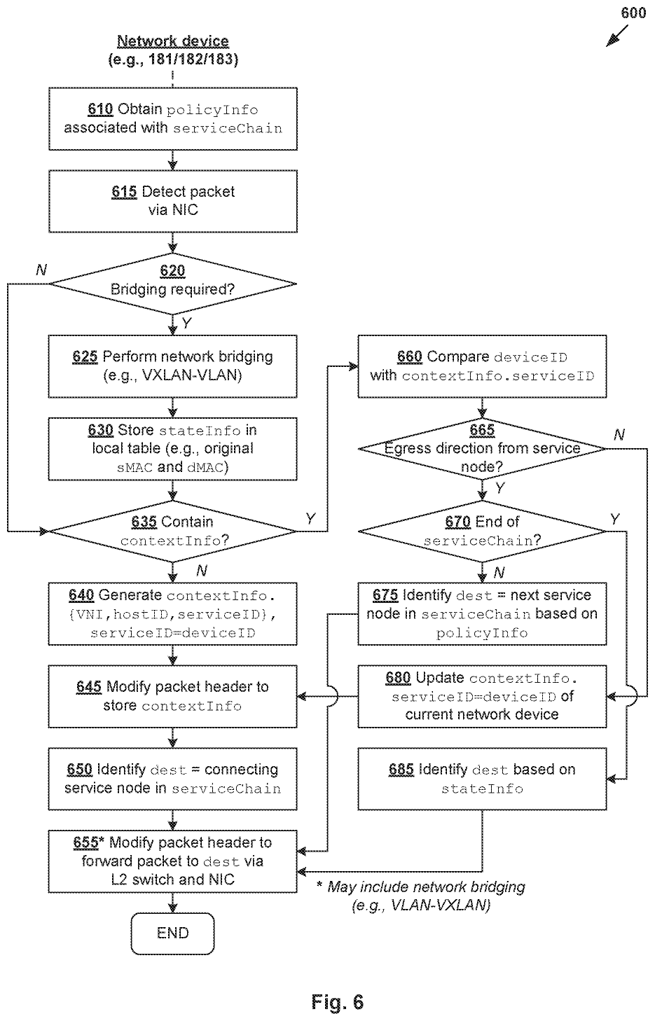

At 230 and 240 in FIG. 2, in response to detecting an ingress packet (see 194 in FIG. 1) travelling from virtualized computing environment 101 towards non-virtualized entity 171, or an egress packet (see 196 in FIG. 1) travelling from non-virtualized entity 171, network device 181 may perform the network interoperability support service by processing the ingress packet or egress packet based on the policy information. As will be discussed using FIGS. 5-6, block 240 may involve modifying an existing packet field (e.g., header or payload field) of the ingress packet to store context information associated with the network interoperability support service. For example, an existing source MAC address field may be used for storing context information. By using an existing packet field, it is not necessary to modify non-virtualized entity 171 to support any extra header and/or payload processing (to be discussed using FIGS. 5-6).

Similar to service(s) provided by hypervisor 114A/114B to corresponding VMs 131-134, network device 181/182/183 may be configured to provide network interoperability support for non-virtualized entity 171/172/173. In practice, the policy information may be obtained to perform any suitable network interoperability support service(s), such as to facilitate implementation of service chaining, micro-segmentation for physical workloads, network observability service (e.g., deep packet inspection, flow monitoring, port mirroring, etc.), sidecar proxy service (e.g., circuit breaker and flow control for legacy services), tunneling service, etc. For example, as will be discussed using FIGS. 5-6, network device 181 may facilitate the implementation of a service chain that includes non-virtualized entity 171 and at least a second non-virtualized entity (e.g., 172/173).

Depending on the desired implementation, a plug-and-play model may be implemented. For example, network device 181/182/183 may be connected with corresponding non-virtualized entity 171/172/173 via a layer-2 connection to activate network interoperability support. Unlike conventional approaches, the location dependence issue that restricts the physical location of non-virtualized entity 171/172/173 (relative to VMs 131-134) may be reduced, if not eliminated. Also, examples of the present disclosure may be implemented without necessitating any modification to non-virtualized entity 171/172/173. This reduces or eliminates any performance degradation issue associated with installing additional software on non-virtualized entity 171/172/173. In practice, network device 181/182/183 may be configured to be extensible, in that new protocol adapters may be installed to interface with virtualized computing environment 101 to reduce any generational mismatch issue. Further, a unified management approach may be used to manage multiple network devices 181-183 via management entity 160, regardless of the vendors of corresponding non-virtualized entities. In the following, various examples will be discussed using FIGS. 3-7.

Configuration

FIG. 3 is a flowchart of an example process for configuring network device 181/182/183 to provide network interoperability support for non-virtualized entity 171/172/173 in network environment 100. Example process 300 may include one or more operations, functions, or actions illustrated by one or more blocks, such as 310 to 374. The various blocks may be combined into fewer blocks, divided into additional blocks, and/or eliminated depending on the desired implementation. In practice, example process 300 may be implemented by any suitable computer system acting as network device 181/182/183.

(a) Configuration Information

At 310 and 315 in FIG. 3, in response to receiving a user's request, management entity 160 generates configuration information (configInfo) for configure network device 181/182/183. In practice, the request may initiated by the user (e.g., network administrator) via a user interface supported by management entity 160, such as a graphical user interface (GUI), command line interface (CLI), application programming interface (API), etc. The “configuration information” may include any suitable information required for bootstrapping network device 181/182/183, such as software image information (swImage) to be installed on network device 181/182/183, security information (securityInfo) for security verification, address information (mgtURL) associated with management entity 160, etc.

In more detail, the term “software image” or “software image information” may refer to a set of software programs to be installed on network device 181/182/183 to implement network interoperability support service(s). Depending on the desired implementation, the software image information may include operating system(s), boot code(s), middleware, application software programs, computer software drivers, software utilities, libraries, or any combination thereof, etc. The “security information” (securityInfo) may be generated using any suitable security protocol, such as code signing protocol (to be discussed below). The “address information” (mgtURL) may include any suitable information that allows network device 181/182/183 to connect with management entity 160, such as an Uniform Resource Locator (URL) that may be resolved to an IP address etc.

(b) Security Verification

At 320 and 325 in FIG. 3, in response to obtaining the configuration information, network device 181/182/183 may perform security verification based on the security information. The security verification may be performed based on a code signing protocol to verify the origin of a software image to be installed. This way, prior to installing the software image on network device 181/182183, the reliability or integrity of the software image obtained from management entity 160 may be assessed, and the likelihood of installing malicious software may be reduced if not avoided. In practice, code signing generally involves using a digital signature, which may be based on a digital certificate issued by a trusted party (e.g., certification authority) that has verified the identity of the software publisher.

For example, at management entity 160, the code signing at block 315 in FIG. 3 may include (a) generating a message digest based on the software image (e.g., using a hash algorithm); (b) encrypting the message digest using a private key; (c) generating a signature block using the encrypted message digest and a digital certificate; and (d) generating signed configuration information by inserting the signature block into a portable executable file. At network device 181/182/183, the security verification at block 325 in FIG. 3 may include (a) verifying the digital certificate; (b) decrypting the original message digest using a public key associated with the private key; (c) generating a new message digest using a hash algorithm; and (d) comparing the decrypted (original) message digest with the new message digest. If the two message digests match, network device 181/182/183 may determine that the configuration information has not been tampered with.

(c) Bootstrapping

At 330 in FIG. 3, once security verification is successful, network device 181/182/183 may proceed with installation using the software image, thereby bootstrapping network device 181/182/183. Depending on the desired implementation, network device 181/182/183 may be configured to be a bump-in-the-wire (BITW) device that is inserted between corresponding non-virtualized entity 171/172/173 and virtualized computing environment 101 (as well as other networks in network environment 100). This way, network device 181/182/183 may serve as a hardware gateway or proxy device that handles the necessary network functions that are required for any interoperability with virtualized computing environment 101 without having to alter non-virtualized entity 171/172/173.

FIG. 4 is a schematic diagram illustrating example architecture 400 for network device 181/182/183 that is configured to provide network interoperability support for non-virtualized entity 171/172/173. It should be understood that, depending on the desired implementation, example architecture 400 may include additional and/or alternative components than that shown in FIG. 4. In this example, network device 181/182/183 may run on a low-cost, single-board computer system, which generally has relatively low space and power requirements. Multiple network interfaces may be used, such as Ethernet interfaces capable of gigabit Ethernet, wireless interfaces (not shown), etc. First Ethernet port (ETH1) 410 may interface with physical network 103. Second Ethernet port (ETH2) 420 may interface with corresponding non-virtualized entity 171/172/173 to provide network interoperability support. The low-power board may use Power over Ethernet (PoE) port for power, etc. Commodity low-cost devices are commercially available that would be suitable for implementing network devices 181-183. Examples include Raspberry Pi® computers available from the Raspberry Pi Foundation and Next Unit of Computing (NUC) devices from Intel Corporation.

The installation at block 330 in FIG. 3 may involve configuring various modules of network device 181/182/183, including layer-2 switching module 430 to perform layer-2 switching; bridging module 440 to perform network bridging (e.g., VXLAN-VLAN); packet processing module 450 to generate and/or modify context information associated with a network interoperability support service (to be discussed further using FIGS. 5-6); and control-plane agent 460 to interface with management entity 160, etc. Network device 181/182/183 further includes datastore 470 (e.g., on-board memory) to store any suitable policy information, context information, etc.

At 335 in FIG. 3, as part of the bootstrapping process, network device 181/182/183 may generate and send an IP address assignment request to a dynamic host configuration protocol (DHCP) server (not shown) or any alternative server. The purpose is to obtain an IP address (deviceIP) to communicate with management entity 160 via control-plane agent 460 in the example in FIG. 4. For example, network device 181-183 may be assigned with respective IP addresses IP-D1, IP-D2, IP-D3. Each network device may be uniquely identifiable using any suitable device identifier (ID), such as D1, D2 and D3 for respective network device 181-183. Any suitable device ID may be used, such as any combination of the hardware device ID, MAC ID, certificate embedded in the software image, etc.

At 340 and 345 in FIG. 3, as part of the bootstrapping process, network device 181/182/183 may generate and send a registration request using address information associated with management entity 160. In practice, this may involve resolving an URL (e.g., www.xyz.com) in the configuration information obtained at block 320 to an IP address (e.g., IP-M) associated with management entity 160.

(d) Policy Information

At 350 and 355 in FIG. 3, in response to receiving the registration request, management entity 160 may register network device 181/182/183 as a managed device, and push any relevant policy information (policyInfo) associated with network interoperability support service(s). At 360 in FIG. 3, network device 181/182/183 obtains and stores the policy information (policyInfo) for subsequent use. It should be understood that the policy information may be modified dynamically to support additional and/or alternative network interoperability support services.

The term “policy information” may refer generally to control information that includes a set of rule(s) for controlling or managing network device 181/182/183. The policy information may be defined by a user (e.g., network administrator) and/or management entity 160. For example, in relation to service chaining (to be discussed using FIGS. 5-6), the policy information may identify a service chain. In relation to micro-segmentation, the policy information may identify firewall rules for enforcement at network device 181/182/183. In relation to network observability services, the policy information may be configured to facilitate deep packet inspection, etc. Any alternative and/or additional policy information may be obtained.

At 365 and 370 in FIG. 3, in response to detecting packet(s) originating from or destined for non-virtualized entity 171/172/173, network device 181/182/183 may perform network interoperability support service(s) by processing the packet(s) based on the policy information. For example, block 370 may involve storing or updating context information (contextInfo) associated with the network interoperability support service(s) in an existing packet field of the each packet (see 372) before forwarding the processed packet to non-virtualized entity 171/172/173 or another destination (see 374). A detailed example of block 370 will be explained using FIGS. 5-6.

Service Chaining Example

According to examples of the present disclosure, network device 181/182/183 may act as a service chaining proxy for non-virtualized entity 171/172/173. Unlike conventionally approaches, it is not necessary for network device 181/182/183 to implement any service chaining protocol in the example in FIGS. 5-6. Using the service chaining proxy implementation, non-virtualized entities 171-173 may achieve greater location independence in that they may be deployed in a location that is independent from that of VMs 131-134. In the following, network devices 181-183 and non-virtualized entities 171-173 will also be referred to as “proxy devices” and “service nodes,” respectively.

As used herein, the term “service chain” or “service path” may refer generally to a chain of multiple service nodes that are each configured to implement a “service”. For example, a service chain may represent a set of services through which traffic is steered. The term “service” in relation to service chaining may include any suitable operation(s) relating to a networking or non-networking service. Example networking services include firewall, load balancing, network address translation (NAT), intrusion detection, deep packet inspection, traffic shaping, traffic optimization, packet header enrichment or modification, packet tagging, or any combination thereof, etc. As will be described further below, each service node maintains context information in the packets to facilitate service chaining.

FIG. 5 is a schematic diagram illustrating example network interoperability support 500 for non-virtualized entities to implement service chaining. Service nodes 171-173 may be chained or grouped together to form a “service chain” (see 501) to provide various services to VMs 131-134 on hosts 110A-B. Service chain 501 may be denoted as serviceChain={Si}, where i=1, . . . , N to implement a sequence of multiple services (e.g., N=3). It should be noted that a service node may or may not modify the content (e.g., header and/or payload) of the packets before the packets (e.g., in a processed form or their original form) are forwarded to the next destination. In cases where the content of the packets is modified, context information relating to service chaining should be maintained in the packets.

The example in FIG. 5 will be explained using FIG. 6, which is a flowchart of first example process 600 for network device 181/182/183 to provide network interoperability support for non-virtualized entity 171/172/173 to implement service chaining. Example process 600 may include one or more operations, functions, or actions illustrated at 610 to 685. The various operations, functions or actions may be combined into fewer blocks, divided into additional blocks, and/or eliminated depending on the desired implementation. The examples in FIG. 5 and FIG. 6 may be implemented by host 110A/110B using virtual switch 115A/115B and service chain handler 117A/117B; network device 181/182/183 using various component(s) in FIG. 4; and non-virtualized entity 171/172/173 using service node module 521/522/523, etc.

In the following, consider a scenario where source VM1 131 supported by host-A 110A sends packets to destination VM3 133 supported by host-B 110B. Prior to forwarding the packets to destination VM3 133, the packets may be steered via service nodes 171-173. Once processed (and not dropped) by service chain 501, the packets will be forwarded to destination VM3 133. For example, source VM1 131 may generate and send packet 531 (labelled “P1”) that is addressed to destination VM3 133. In response to detecting egress packet 531, hypervisor-A 114A may generate and send packet 532 (labelled “P2”) that is addressed from a source VTEP (not shown) at host-A 110A to first service node 171 of service chain 501. Packet processing using service chain 501 may be divided into the following stages.

(a) Virtual to Physical (First Network Device)

At 610 in FIG. 6, after performing a bootstrapping process according to the example in FIG. 3, network devices 181/182/183 may obtain policy information 511/512/513 associated with service chain 501 from management entity 160. In the example in FIG. 5, the policy information may be associated with serviceChain={S1, S2, S3} formed by service nodes 171-173. Address information (e.g., MAC and IP addresses) associated with service nodes 171-173 may be obtained from management entity 160, such as using control-plane agent 460 in FIG. 4.

At 615 and 620 in FIG. 6, in response to detecting packet 532 (labelled “P2”) originating from virtualized computing environment 101 via ETH1 410, first network device 181 may determine whether network bridging is required. In practice, the “bridging” functionality may be implemented to enable communication between a “virtual world” (e.g., VMs 131-134 deployed in virtualized computing environment 101), and a “physical world” (e.g., service nodes 171-173 in (physical) non-virtualized computing environment 102). Using VXLAN-VLAN bridging as an example, VM1 131 and VM3 133 may reside on a VXLAN with VNI=6000, while service nodes 171-173 on VLAN 10.

At 625 and 630 in FIG. 6, first network device 181 may perform network bridging (e.g., VXLAN-VLAN) and store state information in a local table. In the example in FIG. 5, packet “P2” 532 may be an encapsulated packet with outer header information that identifies VNI=6000 associated with a VXLAN on which VM1 131 is located. In this case, “network bridging” at block 630 may involve translating VNI=6000 to VLAN 10 on which service nodes 181-183 are located. By allocating a separate a VLAN for service nodes 171-173, other (irrelevant) layer-2 packets are not forwarded to service chain 501 (not shown in FIG. 6 for simplicity). Depending on the desired implementation, allocation of a separate VLAN may be omitted in practice. The state information stored at block 630 may be any suitable packet header and/or payload information, such as the original source MAC address and destination MAC address of packet “P2” 532.

At 635 in FIG. 6, first network device 181 may determine that packet “P2” 532 is at the start of the service chain, such as by checking whether packet 532 includes any context information (contextInfo). In relation to service chaining, the context information may be service chain context (SCC) information that includes a VNI (e.g., 24 bits), host-ID (e.g., 12 bits) and service-ID (e.g., 12 bits). In practice, the host-ID may be any suitable information for identifying source VM1 131, such as a unique ID that is generated based on pair=(VNI=600, VM1) at network device 181. The VNI and host-ID may remain constant as packets travel through service chain 501. However, as will be exemplified below, the service-ID may be modified to indicate their location along service chain 501. Any additional and/or alternative context information to facilitate service chaining may be used.

In practice, location tracking ensures that service nodes 171-173 process packets according to a particular order. In the example in FIGS. 5-6, each packet may be configured with context information that specifies a service-ID for location tracking, such as using a device-ID associated with network devices 181-183. Unlike conventional approaches, examples of the present disclosure do not necessitate the use of a service chaining protocol. Such protocol generally requires extra header and/or payload to the original packet, which cannot be parsed by legacy service nodes without hardware and/or software modification. The extra header and/or payload may also affect the performance of service nodes.

Instead of adding extra header(s) or payload to packet “P2” 532 to store the context information, examples of the present disclosure may use an existing packet field to store the context information, such as an existing source MAC field of a layer-2 header of packet 532, etc. In practice, the source MAC field is usually part of a standardized Ethernet header, thereby reducing or avoiding any interoperability issues at service nodes 171-173. This approach is transparent to service nodes 171-173, and does not require any modification to parse extra header(s) and/or payload.

At 640 and 645 in FIG. 6, in response to determination that packet “P2” 532 does not include any context information, first network device 181 may generate context information (VNI=6000, host-ID, service-ID=D1), and modify a layer-2 header field (e.g., source MAC) to store the context information. As shown in FIG. 5, the resulting packet 533 (labelled “P3”) includes service-ID=D1, which is the device-ID=D1 of first network device 181.

At 650 and 655 in FIG. 6, first network device 181 may identify connecting service node 171 to be the next destination, and perform layer-2 switching to forward packet 533 (labelled “P3”) to first service node 171 via ETH2 480. In response to detecting packet “P3” 533, first service node 171 performs packet processing, after which processed packet 534 (labelled “P4”) is forwarded to first network device 181.

Packet “P4” 534 may be processed as follows. Based on a comparison between (a) device-ID=D1 and (b) service-ID=D1 in packet “P4” 534, second network device 182 may determine that the packet is travelling in an egress direction from first service node 171. Since the end of service chain 501 has not been reached, next destination=second service node 172 may be identified based on policy information 511. Next, the header information of packet “P4” 534 may be modified to specify destination address (e.g., MAC address=MAC-S2) associated with second service node 172. The resulting packet 535 (labelled “P5”) is then forwarded to second service node 172. See blocks 615, 660, 665 (yes), 670 (no), 675 and 655 in FIG. 6.

(b) Physical to Physical (Second Network Device)

Packet “P5” 535 may be processed using the example in FIG. 6 as follows. Based on a comparison between (a) device-ID=D2 associated with second network device 182 and (b) service-ID=D1 in packet “P5” 535, second network device 182 may determine that the packet is travelling in an ingress direction towards second service node 172. In this case, the context information may be updated to service-ID=D2 while (VNI, host-ID) remain unchanged. The resulting packet 536 (labelled “P6”) is then forwarded to second service node 172 for packet processing, which generates packet 537 (labelled “P7”) after packet processing according to a second service in service chain 501. See blocks 615, 635 (yes), 660, 665 (no), 680, and 645-655 in FIG. 6.

Packet “P7” 537 may be processed as follows. Based on a comparison between (a) device-ID=D2 and (b) service-ID=D2 in packet “P7” 537, second network device 182 may determine that packet “P7” 537 is travelling in an egress direction from second service node 172. Since the end of service chain 501 has not been reached, next destination=third service node 173 may be identified based on policy information 512. As such, packet “P8” 538 with destination address (e.g., MAC address=MAC-S3) associated with third service node 173 will be sent. See blocks 615, 660, 665 (yes), 670 (no), 675 and 655 in FIG. 6.

(c) Physical to Virtual (Third Network Device)

Packet “P8” 538 may be processed as follows. Based on a comparison between (a) device-ID=D3 of third network device 183 and (b) service-ID=D2 in packet “P8” 538, third network device 183 may determine that the packet is travelling in an ingress direction towards third service node 173. In this case, the context information may be updated to service-ID=D3. The resulting packet 539 (labelled “P9”) is then forwarded to third service node 173, which generates packet 540 (labelled “P10”) after packet processing according to a third service in service chain 501. See blocks 615, 635 (yes), 660, 665 (no), 680, and 645-655 in FIG. 6.

Packet “P10” 537 may be processed as follows. Based on a comparison between (a) device-ID=D3 and (b) service-ID=D3 in packet “P7” 537, third network device 183 may determine that the packet is travelling in an egress direction from third service node 173. Since the end of service chain 501 has been reached, packet “P11” 541 may be bridged back (using VXLAN-VLAN bridging module 440 in FIG. 4) to a VXLAN network on which destination VM3 133 is located. See packets “P11” 541 and “P12” 542 in FIG. 5. Alternatively, if the destination is a non-managed device, the packet may be forwarded using L2 switch 430. See blocks 615, 660, 665 (yes), 670 (no), 675 and 655 in FIG. 6.

Depending on the desired implementation, third network device 183 (i.e., final proxy device) may forward packet “P11” 541 to first network device 181 (i.e., first proxy device) for modification and subsequent transmission to destination VM2 132. In this case, based on the state information stored at block 630, first network device 181 may configure packet “P11” 541 to specify a source MAC address associated with VM1 131, and a destination MAC address associated with VM2 132.

### Other Examples

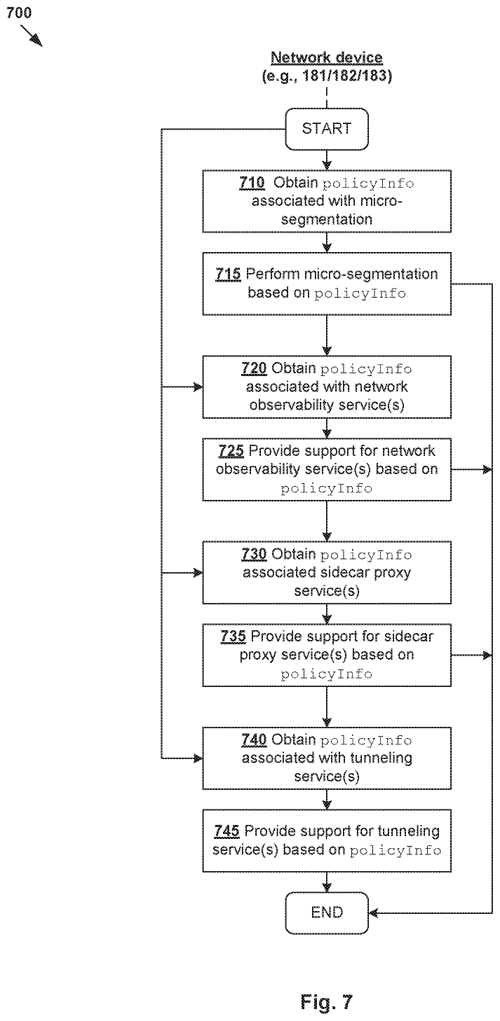

Besides network interoperability support for service chaining, examples of the present disclosure may be implemented for any alternative and/or additional network functions. Some examples will be discussed using FIG. 7, which is a flowchart of second example process 700 for network device 181/182/183 to provide network interoperability support for non-virtualized entity 171/172/173. Example process 700 may include one or more operations, functions, or actions illustrated at 710 to 745. The various operations, functions or actions may be combined into fewer blocks, divided into additional blocks, and/or eliminated depending on the desired implementation. It should be understood that any additional and/or alternative services may be supported.

At 710 and 715 in FIG. 7, network device 181/182/183 may obtain policy information to implement micro-segmentation for non-virtualized entity 171/172/173. In virtualized computing environment 101, hypervisor 114A/114B may implement a distributed firewall to filter traffic to and from corresponding VMs 131-134. According to examples of the present disclosure, this functionality may be extended to physical workloads. In this case, the policy information may include firewall rules that are applicable to packets to and/or from non-virtualized entity 171/172/173.

In practice, a firewall rule may be defined using five tuples: source network address, source port number (PN), destination network address, destination PN, and protocol, in addition to an action (e.g., allow or deny). An acceptable value, or range of values, may be specified for each tuple. The protocol tuple (also known as service) may be set to transmission control protocol (TCP), user datagram protocol (UDP), hypertext transfer protocol (HTTP), HTTP Secure (HTTPS), etc.

At 720 and 725 in FIG. 7, network device 181/182/183 may obtain policy information to provide network observability service(s) for non-virtualized entity 171/172/173. Example network observability services include flow monitoring, port mirroring, deep packet inspection, etc. In practice, port mirroring is a switch feature that may be configured between a pair of ports. During a port mirroring session identified by the policy information, packets passing through one port of network device 181/182/183 connected to non-virtualized entity 171/172/173 may be mirrored to another port (e.g., another network device).

At 730 and 735 in FIG. 7, network device 181/182/183 may obtain policy information to provide sidecar proxy service(s) for non-virtualized entity 171/172/173. In practice, sidecar proxy service(s) may be used to implement various patterns such as circuit breaker and flow control for legacy services that are not capable of such functionality. For example, network device 181/182/183 may be configured to monitor traffic to and/or from non-virtualized entity 171/172/173 to detect any network issue, such as packet dropping rate exceeding a threshold, etc. In this case, the policy information may specify any suitable set of scenario-action pairs for triggering network device 181/182/183 to perform a predetermined action in response to detecting a particular scenario. Example actions may include informing a management entity on the control plane, redirecting packets to another entity automatically, etc.

At 740 and 745 in FIG. 7, network device 181/182/183 may obtain policy information to provide tunneling service(s) for non-virtualized entity 171/172/173. For example, network device 181/182/183 may implement a tunneling protocol such as Internet Protocol Security (IPSec) to provide IPSec VPN capability for non-virtualized entity 171/172/173. In practice, network device 181/182/183 may implement a PTEP (proxy tunnel endpoint) to implement, for example, handle packet replication of broadcast, unknown unicast and multicast (BUM) traffic. Similarly, the policy information may specify any suitable set of scenario-action pairs for triggering network device 181/182/183 to perform a predetermined action in response to detecting a particular scenario associated with the tunneling service.

Container Implementation

Although explained using VMs 131-134, it should be understood that network environment 100 may include other virtual workloads, such as containers, etc. As used herein, the term “container” (also known as “container instance”) is used generally to describe an application that is encapsulated with all its dependencies (e.g., binaries, libraries, etc.). In the examples in FIG. 1 to FIG. 7, container technologies may be used to run various containers inside respective VMs 131-134. Containers are “OS-less”, meaning that they do not include any OS that could weigh 10 s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies. The containers may be executed as isolated processes inside respective VMs.

Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 7. For example, a computer system capable of acting as network device 181/182/183 may be deployed in network environment 100.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

We claim:

1. A method for a network device to provide network interoperability support for a non-virtualized entity in a network environment, wherein the method comprises:
based on configuration information that is generated by a management entity and associated with a network interoperability support service, performing security verification and one or more configuration operations to configure a network interoperability support service on the network device;
obtaining, from the management entity, policy information associated with the network interoperability support service; and
in response to detecting an ingress packet travelling from a virtualized computing environment towards the non-virtualized entity, or an egress packet travelling from the non-virtualized entity, performing the network interoperability support service by processing the ingress packet or egress packet based on the policy information.

2. The method of claim 1, wherein performing the network interoperability support service comprises:
modifying an existing packet field of the ingress packet to store context information associated with the network interoperability support service, wherein the existing packet field is a header field or a payload field.

3. The method of claim 1, wherein performing the network interoperability support service comprises:
based on the policy information, performing the network interoperability support service to facilitate implementation of a service chain formed by the non-virtualized entity and at least a second non-virtualized entity.

4. The method of claim 1, wherein performing the network interoperability support service comprises:
performing the network interoperability support service to implement one or more of the following for the non-virtualized entity: micro-segmentation, network observability service, sidecar proxy service, and tunnelling service.

5. The method of claim 1, wherein performing the security verification comprises:
performing security verification based on security information in the configuration information prior to installing software image information to configure the network interoperability support service.

6. The method of claim 1, wherein obtaining the policy information comprises:
based on the configuration information, determining address information associated with the management entity; and
generating and sending a request to the management entity using the address information to register the network device and to obtain the policy information.

7. The method of claim 1, wherein performing the one or more configuration operations comprises at least one of the following:
configuring a bridging module of the network device to perform network bridging from a virtual network in the virtualized computing environment to a physical network in which the non-virtualized entity is located;
configuring a layer-2 switching module to perform layer-2 bridging;
configuring a control-plane agent of the network device to interact with the management entity to obtain the policy information; and
configuring a packet processing module to perform the network interoperability support service.

8. A non-transitory computer-readable storage medium that includes a set of instructions which, in response to execution by a processor of a network device, cause the processor to perform a method of providing network interoperability support for a non-virtualized entity in a network environment, wherein the method comprises:
based on configuration information that is generated by a management entity and associated with a network interoperability support service, performing security verification and one or more configuration operations to configure a network interoperability support service on the network device;
obtaining, from the management entity, policy information associated with the network interoperability support service; and
in response to detecting an ingress packet travelling from a virtualized computing environment towards the non-virtualized entity, or an egress packet travelling from the non-virtualized entity, performing the network interoperability support service by processing the ingress packet or egress packet based on the policy information.

9. The non-transitory computer-readable storage medium of claim 8, wherein performing the network interoperability support service comprises:
modifying an existing packet field of the ingress packet to store context information associated with the network interoperability support service, wherein the existing packet field is a header field or a payload field.

10. The non-transitory computer-readable storage medium of claim 8, wherein performing the network interoperability support service comprises:
based on the policy information, performing the network interoperability support service to facilitate implementation of a service chain formed by the non-virtualized entity and at least a second non-virtualized entity.

11. The non-transitory computer-readable storage medium of claim 8, wherein performing the network interoperability support service comprises:
performing the network interoperability support service to implement one or more of the following for the non-virtualized entity: micro-segmentation, network observability service, sidecar proxy service, and tunnelling service.

12. The non-transitory computer-readable storage medium of claim 8, wherein performing the security verification comprises:
performing security verification based on security information in the configuration information prior to installing software image information to configure the network interoperability support service.

13. The non-transitory computer-readable storage medium of claim 8, wherein obtaining the policy information comprises:
based on the configuration information, determining address information associated with the management entity; and
generating and sending a request to the management entity using the address information to register the network device and to obtain the policy information.

14. The non-transitory computer-readable storage medium of claim 8, wherein performing the one or more configuration operations comprises at least one of the following:
configuring a bridging module of the network device to perform network bridging from a virtual network in the virtualized computing environment to a physical network in which the non-virtualized entity is located;
configuring a layer-2 switching module of the network device to perform layer-2 bridging;
configuring a control-plane agent of the network device to interact with the management entity to obtain the policy information; and
configuring a packet processing module of the network device to perform the network interoperability support service.

15. A computer system configured to provide network interoperability support for a non-virtualized entity in a network environment, wherein the computer system comprises:
a processor; and
a non-transitory computer-readable medium having stored thereon instructions that, when executed by the processor, cause the processor to:
based on configuration information that is generated by a management entity and associated with a network interoperability support service, perform security verification and one or more configuration operations to configure a network interoperability support service on the computer system; and
obtain, from the management entity, policy information associated with the network interoperability support service; and
in response to detecting an ingress packet travelling from a virtualized computing environment towards the non-virtualized entity, or an egress packet travelling from the non-virtualized entity, perform the network interoperability support service by processing the ingress packet or egress packet based on the policy information.

16. The computer system of claim 15, wherein the instructions for performing the network interoperability support service cause the processor to:
modify an existing packet field of the ingress packet to store context information associated with the network interoperability support service, wherein the existing packet field is a header field or a payload field.

17. The computer system of claim 15, wherein the instructions for performing the network interoperability support service cause the processor to:
based on the policy information, perform the network interoperability support service to facilitate implementation of a service chain formed by the non-virtualized entity and at least a second non-virtualized entity.

18. The computer system of claim 15, wherein the instructions for performing the network interoperability support service cause the processor to:
perform the network interoperability support service to implement one or more of the following for the non-virtualized entity: micro-segmentation, network observability service, sidecar proxy service, and tunnelling service.

19. The computer system of claim 15, wherein the instructions for performing the security verification cause the processor to:
perform security verification based on security information in the configuration information prior to installing software image information to configure the network interoperability support service.

20. The computer system of claim 15, wherein the instructions for obtaining the policy information cause the processor to:
based on the configuration information, determine address information associated with the management entity; and
generate and send a request to the management entity using the address information to register the computer system and to obtain the policy information.

21. The computer system of claim 15, wherein the instructions for performing the one or more configuration operations cause the processor to perform at least one of the following:
configure a bridging module to perform network bridging from a virtual network in the virtualized computing environment to a physical network in which the non-virtualized entity is located;
configure a layer-2 switching module to perform layer-2 bridging;
configure a control-plane agent to interact with the management entity to obtain the policy information; and
configure a packet processing module to perform the network interoperability support service.
